(19) United States
(12) Patent Application Publication
(10) Pub. No.: US 2014/0352124 A1
(43) Pub. Date: Dec. 4, 2014

(54) TOOL AND METHOD FOR DECOUPLING TEMPORARY PIPES

(71) Applicant: Sanexen Environmental Services, Inc., Brossard (CA)

(72) Inventor: Éric BÉRUBÉ, Repentigny (CA)

(21) Appl. No.: 13/903,133

(22) Filed: May 28, 2013

(51) Int. Cl. F16L 1/06; B25B 27/06

(52) U.S. Cl. CPC F16L 1/06; B25B 27/06
USPC 29/426.5; 29/280

(57) ABSTRACT

A striking tool removing a collar from a temporary pipe is disclosed, the tool comprising a striking heed, a handle and a shaft connecting the striking head to the handle, the striking head including a semi-circular arc shaped plate having an inner radius “R” substantially equal to half of the outer diameter of the pipe, and a striking portion defined by an edge of the semi-circular arc shaped plate.

### FIELD OF THE INVENTION

The present invention relates to a tool adapted to decouple temporary pipes joined or coupled together with collars and a method of decoupling temporary pipes connected together with collars.

### BACKGROUND OF THE INVENTION

Temporary piping systems are used when for example rehabilitation work is performed on permanent underground potable water main systems or sewage systems and services must be maintained to the residences and/or industries affected while work is being done on the permanent underground water system. Water supply is re-routed into a network of pipes usually laid directly on the ground and joined together end to end with hermetic collars; the network of pipes being temporarily connected to the affected residences and/or industries in order to maintain water supply or sewage services while the permanent underground water system is shut down.

The temporary pipes network typically consists of a series of PVC pipes of various lengths connected end to end via hermetic PVC collars. Polyvinyl chloride (PVC) is predominantly used for temporary pipes network for its lightness, resistance to impact, and resistance to sunlight and harsh environment in general. However, other polymer-based materials having similar physical properties may be used to produce similar pipes and collars, such as for example chlorinated polyvinyl chloride (CPVC), fiber reinforced plastic (FRP), polypropylene (PP), polyethylene (PE), cross-linked high-density polyethylene (XHDPE), polybutylene (PB), and acrylonitrile butadiene styrene (ABS), etc.

When work is completed on the permanent underground water system, the affected residences and/or industries are re-connected to the permanent underground water system and the temporary pipes network is dismantled and removed.

The dismantling of the temporary pipes network has proven to be difficult and time consuming because the hermetic collars connecting the various lengths of pipes end to end are press-fitted onto the outer diameter of the connected pipes. One of the connected pipes must be mechanically restrained while the other is pulled in order to slide it out of the hermetic collar. The mechanical force required to pull an often long and hard to handle pipe and slide it out of the collar is such that tractors and chains are required to perform this task. The use of heavy equipment for simply disconnecting pipes coupled with hermetic collar in order to dismantle the temporary pipes network makes the whole dismantling process as expensive as its assembly. To help in this process, workers will often place a piece of wood against the side of the collar and use a hammer to try to break the seal between the collar and pipes and dislodge the collar with limited success.

Therefore, there is a need for a method and for a tool that make the dismantling of temporary pipes network consisting of polymer-based pipes of various lengths connected end to end via hermetic collars more efficient and less expensive.

### SUMMARY OF THE INVENTION

It is an object of the present invention to ameliorate at least some of the inconveniences present in the prior art.

It is also an object of the present invention to provide a tool for removing a collar from a temporary pipe having an outer diameter, the tool comprising a striking head, a handle and a shaft connecting the striking head to the handle, the striking head including a semi-circular are shaped metal plate having an inner radius “R” substantially equal to half of the outer diameter of the pipe, and a striking portion defined by an edge of the semi-circular arc shaped metal plate.

It is also an object of the present invention to provide a method of removing a collar from a temporary pipe having an outer diameter using a tool as defined in claim 1, the method comprising the steps of: setting the striking head of the tool on the pipe next to the collar; and repeatedly striking the collar with the edge of the striking head by sliding the striking head back and forth on the outer surface of the pipe until the collar is dislodged from pipe.

Embodiments of the present invention each have at least one of the Above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 a schematic top plan view of a portion of a temporary polymer-based pipe network installed in a residential neighborhood;

FIG. 2 is a perspective view of two polymer-based pipes connected together end to end with an hermetic polymer-based collar;

FIG. 3a a perspective view of a striking tool in accordance with one embodiment of the invention;

FIG. 3b is a front elevational view of the striking tool shown in FIG. 3a;

FIG. 3c is a side elevational view of the striking tool shown in FIG. 3a; and

FIG. 4 a perspective view of two polymer-based pipes connected together end to end with an hermetic polymer-based collar with the striking tool shown in FIG. 3a;

### DETAILED DESCRIPTION OF THE PREFERRED EMBODIMENTS

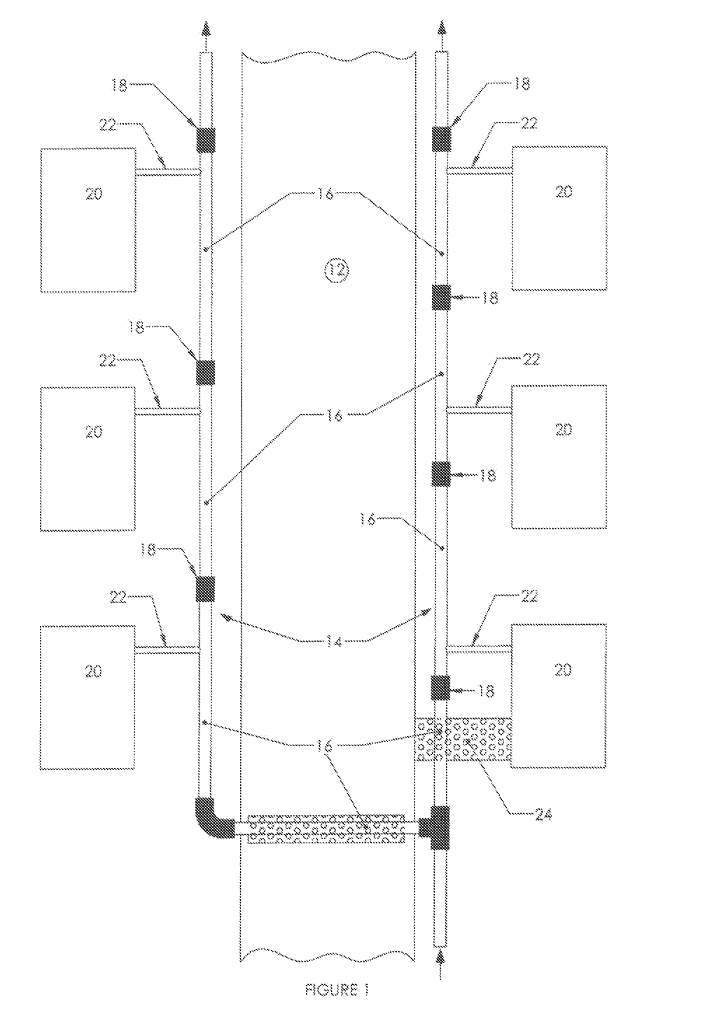

With reference to FIG. 1, there is shown a portion of a street 12 in a residential neighborhood in which a temporary pipe network 14 is installed aboveground while work is being done on the permanent underground water system not shown). The temporary pipe network 14 consists of a series of polymer-based pipes 16 (typically PVC pipes) of various lengths laid directly on the ground and connected together end to end by hermetic collars 18 made of the same material as the pipes 16. The pipes 16 are typically 4 to 8 inches in diameter but may be as big as 16 inches in diameter. The temporary pipe network 14 is connected to the affected residences 20 via smaller diameter pipes or flexible hoses 22 of less than one inch in diameter tapped into the main pipes 16 of the temporary pipe network 14 in order to maintain water supply to each residence 20. Gravel is used to cover the polymer-based pipes 16 laid across the street 12 and across the driveway 24 of a residence 20 to enable vehicles to drive over the pipes 16.

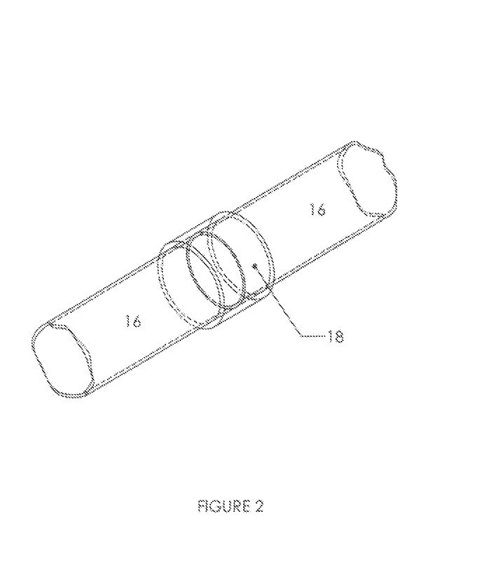

With reference to FIG. 2, the pipes 16 are connected together end to end with an hermetic collar 18 having an inside diameter exactly the same as the outside diameter of the pipes 16 such that the collar 18 fits snugly around the ends of the pipes 16 providing a press-fitted joint. When installed, a liquid sealant may be applied to the outer surfaces of the pipes 16 in order to ease the insertion of the collar 18 onto the ends of the pipes 16 which eventually dries and renders the assembly hermetic. Some collars 18 are mechanically locked and sealed unto the ends of the abutting pipes 16 by using grooves machined on the end of the pipes 16 and inside the collars 18 which are aligned together and a spline is inserted in the aligned grooves to lock the assembly. Flexible O-rings may also be used to seal the coupling.

When work is completed on the permanent underground water system, the residences 20 are re-connected thereto and the temporary pipe network 14 must be dismantled and removed from the premises. In order to dismantle the temporary pipe network 14, the collars 18 must be removed and the pipes 16 separated. To accelerate the removal of the collars 18, the inventors have devised a striking tool 25 specifically adapted for the purpose.

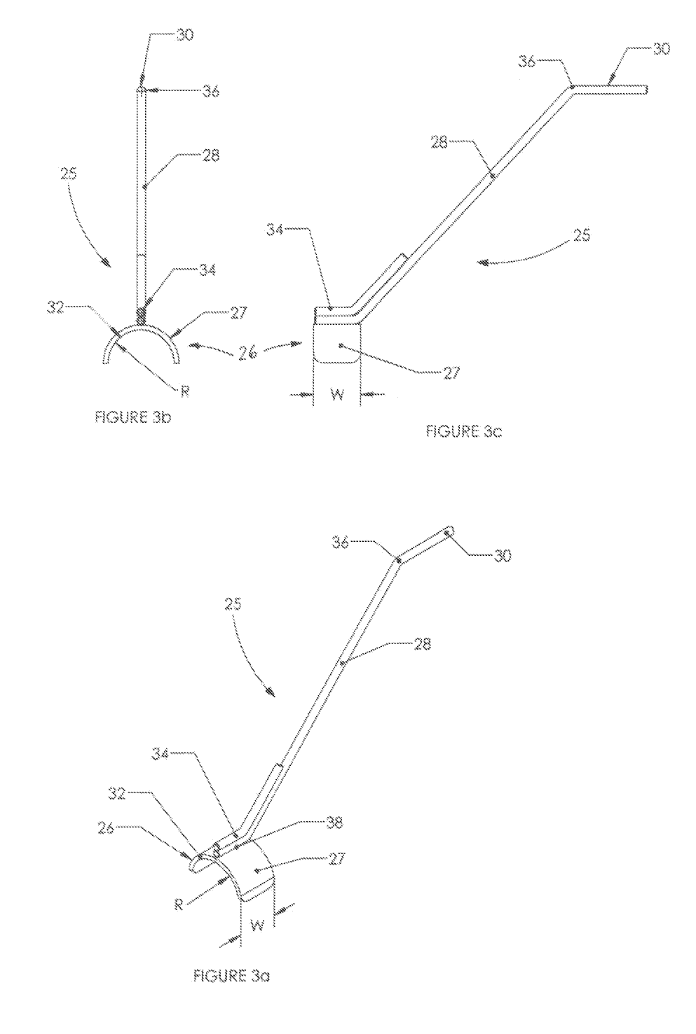

With reference to FIGS. 3a, 3b and 3c, there is shown a striking tool 25 in accordance with one specific embodiment of the invention. The striking tool 25 comprises a striking head 26, a shaft 28 connected to the striking head 26 and a handle 30 connected to the end pardon of the shaft 28. The striking head 26 consists of a semi-circular arc shaped heavy metal plate 27 having a thickness of about ½ inch and an inner radius “R” substantially equal to half of the outer diameter (or outer radius) of the pipes 16 to be dismantled. The edge 32 of the send-circular heavy metal plate 27 is the striking portion of the striking head 26. The width “w” of the semi-circular heavy metal plate 27 provides rigidity and weight to the striking head 26. The shaft 28 is a heavy metal rod bent at both end 34 and 36; the end 34 is welded to the top portion of the semi-circular heavy metal plate 27 with a weld 38 and the end 36 is bent to form the handle 30.

The striking head 24 of the striking tool 25 is designed for removing collars 18 from a specific pipe having a specific outer diameter. The radius “R” of the semi-circular metal plate 27 is set and corresponds to is specific pipe outer radius. To remove collars 18 from a pipe having a different outer diameter, a different striking head 26 must be used having a radius “R” which corresponds to the outer radius of the pipe. For example, to remove a collar 18 from a pipe having an outer diameter of 6 inches, a striking head 26 having a radius “R” of 3 inches must be used whereas to remove a collar 18 from a pipe having an outer diameter of 8 inches a striking head 26 having a radius “R” of 4 inches must be used. Thus, each outer diameter of pipe requires a specific striking head 26 having a corresponding radius “R”.

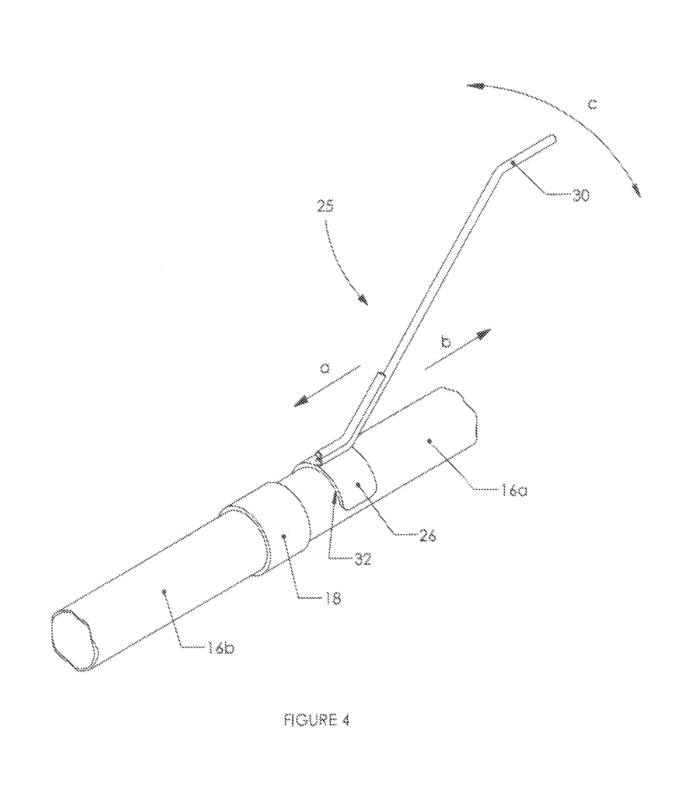

With reference to FIG. 4, in operation, the striking head 26 of the striking tool 25 is set down on the polymer-based pipe 16a next to the hermetically sealed collar 18 and the operator strikes the edge of the collar 18 with the edge 32 of the striking head 26 by sliding the striking head 26 on the outer surface of the pipe 16a as indicated by arrow ‘a’. The operator then slides the striking head 26 back to its initial position as indicated by arrow ‘b’ and again strikes the collar 18 with the striking head 26 repeating this cycle until the collar 18 is dislodged from pipe 16a. White striking the collar 18 repeatedly with the striking tool 25, the operator preferably tilts the handle 30 sideways as indicated by the double-arrow ‘c’ in order to move the striking head 26 along the circumference of the pipe 16a and strike the collar 18 at multiple points along its circumference thereby spreading the impact forces over a substantial portion of the circumference of the collar 18 and increasing the efficiency of striking tool 25 to dislodge the collar 18.

Once the first pipe 16a is freed from the collar 18, it is removed. The operator then positions the striking tool 25 on the second pipe 16b next to the collar 18 still attached thereto and strikes the collar 18 with the striking tool 25 as described above until the collar 18 is dislodged from the second pipe 16b.

The striking tool 25 enables quick and easy dismantling of a temporary pipes network 14 by providing a means to remove the collars 18 from the pipes 16 without requiring heavy machinery.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A tool the removing a collar from a temporary pipe having an outer diameter, the tool comprising a striking head, a handle and a shaft connecting the striking head to the handle, the striking head including a semi-circular arc shaped plate having an inner radius “R” substantially equal to half of the outer diameter of the pipe, and a striking portion defined by an edge of the semi-circular are shaped plate.

2. A tool as defined in claim 1, wherein the semi-circular arc shaped plate includes a width “w”, the width “w” providing rigidity and weight to the striking head.

3. A tool as defined in claim 1, wherein the edge of the semi-circular arc shaped plate is defined by a thickness of the semi-circular arc shaped plate.

4. A method of removing a collar from a temporary pipe having an outer diameter using a tool as defined in claim 1, the method comprising the steps of:
setting the striking head of the tool on the pipe next to the collar; and
repeatedly striking the collar with the edge of the striking head by sliding the striking head back and forth on the outer surface of the pipe until the collar is dislodged from pipe.

5. A method as defined in claim 4, further comprising the step of moving the striking head along a circumference of the pipe between each strike in order to spread the impact forces of the striking head over a substantial portion of a circumference of the collar.
